(19) United States
(12) Patent Application Publication
(10) Pub. No.: US 2020/0175535 A1
(43) Pub. Date: Jun. 4, 2020

(54) SYSTEM AND METHOD FOR TRAFFIC CONTROL IN ONLINE PLATFORM

(71) Applicant: ALIBABA GROUP HOLDING LIMITED, GRAND CAYMAN (KY)

(72) Inventors: Hua XU, Fremont, CA (US); Guang YANG, HANGZHOU (CN); Chi ZHANG, HANGZHOU (CN); Jun YIN, HANGZHOU (CN); Kaifan YANG, HANGZHOU (CN); Chuang TIAN, HANGZHOU (CN); Cheng YANG, HANGZHOU (CN); Shenghuo ZHU, Bellevue, WA (US); Rong JIN, Sammamish, WA (US)

(21) Appl. No.: 16/629,007

(22) PCT Filed: Jul. 7, 2017
(86) PCT No.: PCT/CN2017/092239

§ 371 Date: Jan. 6, 2020

(51) Int. Cl. G06Q 30/02; G06F 16/957; G06Q 30/06

(52) U.S. Cl. CPC G06Q 30/0211; G06F 16/957; G06Q 30/0201; G06Q 30/0222; G06Q 30/0641

(57) ABSTRACT

Systems and methods are provided for online traffic dynamical adjustment and optimization. A such system may comprise one or more servers configured to monitor an incoming traffic volume for visiting an online platform, determine one or more unit traffic values of the monitored incoming traffic volume to the online platform, and monitor one or more subsets of the incoming traffic volume for respectively visiting one or more sub-platforms of the online platform.

### FIELD OF THE INVENTION

This disclosure generally relates to approaches and techniques for traffic control in online platforms.

### BACKGROUND

Online platforms nowadays provide various services to users. Controlling the internet traffic, whether to or within the platform, is significant to its operation and performance. In current technologies, it is challenging to effectuate the traffic flow control in a large volume, to the extent of dynamically optimizing the gain for the platform and its users.

### SUMMARY

Various embodiments of the present disclosure can include systems, methods, and non-transitory computer readable media configured to perform online traffic dynamical adjustment and optimization. An online traffic dynamical adjustment and optimization system may comprise one or more servers configured to monitor an incoming traffic volume for visiting an online platform, determine one or more unit traffic values of the monitored incoming traffic volume to the online platform based at least in part on at least one of a channel of the visit, a user set associated with the traffic, or a time of the visit, and monitor one or more subsets of the incoming traffic volume for respectively visiting one or more sub-platforms of the online platform. For a sub-platform, for which a traffic volume subset is monitored, the one or more servers may be further configured to determine a target traffic volume by a predetermined time, determine if the traffic volume subset will meet the target traffic volume by the predetermined time, in response to determining that the traffic volume subset will not meet the target traffic volume by the predetermined time, determine a first amount of traffic units for boosting the traffic volume subset based at least in part on the unit traffic value, and direct the first amount of traffic units to the corresponding sub-platform.

In some embodiments, to determine the target traffic volume by the predetermined time, the one or more servers are configured to determine the target traffic volume by the end of a fixed time period. To determine the target traffic volume by the predetermined time, the one or more servers are configured to determine the target traffic volume by the predetermined time based at least in part on the traffic volume subset of the sub-platform, for which the traffic volume subset is monitored. The incoming traffic volume for visiting the online platform may increase during the fixed time period.

In some embodiments, the first amount of traffic units may include at least one of a second amount of traffic units or a third amount of traffic units. For the sub-platform, for which the traffic volume subset is monitored, the one or more servers may be further configured to obtain the second amount of traffic units from the incoming traffic volume without the traffic volume subset to the corresponding sub-platform, and obtain the third amount of traffic units from outside the incoming traffic volume.

In some embodiments, for the sub-platform, for which the traffic volume subset is monitored, the one or more servers may be further configured to determine a fourth amount of traffic units based at least in part on the unit traffic value, and in response to detecting, at or after the predetermined time, that the traffic volume subset did not meet the target traffic volume, direct the fourth amount of traffic units to the sub-platform.

In some embodiments, for the sub-platform, for which the traffic volume subset is monitored, the one or more servers may be further configured to determine a contribution to be made to the online platform based at least in part on the unit traffic value.

In some embodiments, to determine the contribution to be made to the online platform, the one or more servers may be configured to determine the contribution based at least in part on a Bernstein Inequality.

In some embodiments, the contribution may comprise at least one of a fifth amount of traffic units outside the incoming traffic volume or an amount of user benefits.

In some embodiments, for the sub-platform, for which the traffic volume subset is monitored, the one or more servers may be further configured to receive the fifth amount of traffic units associated with the sub-platform and direct at least a part of the received fifth amount of traffic units to another sub-platform.

In some embodiments, for the sub-platform, for which the traffic volume subset is monitored, the one or more servers may be further configured to determine the amount of user benefits based at least in part on at least one of a number of users receiving the user benefits, a gross merchandise volume associated with users applying the user benefits, a number of users not receiving the user benefits, a gross merchandise volume associated with users not applying the user benefits, or a total value associated with the user benefits.

In some embodiments, an online traffic dynamical adjustment and optimization system may comprise one or more servers configured to monitor an incoming traffic volume for visiting an online platform and determine one or more unit traffic values of the monitored incoming traffic volume to the online platform based at least in part on at least one of a channel of the visit, a user set associated with the traffic, or a time of the visit. For each of a plurality of sub-platforms of the online platform, the plurality of sub-platform comprising one or more first sub-platforms and one or more second sub-platforms, the one or more servers may be further configured to monitor a first subset of the incoming traffic volume for visiting the first sub-platform and a second subset of the incoming traffic volume for visiting the second sub-platform, determine a first target traffic volume for the first sub-platform by a predetermined time based at least in part on the monitored first subset, determine a second target traffic volume for the second sub-platform by the predetermined time based at least in part on the monitored second subset, determine if the monitored first subset will meet the first target traffic volume by the predetermined time, and determine if the monitored second subset will meet the second target traffic volume by the predetermined time. In response to determining that the monitored first traffic volume subset will not meet the first target traffic volume by the predetermined time and the monitored second traffic volume subset will not meet the second target traffic volume by the predetermined time, the one or more servers may be further configured to determine a first amount of traffic units for boosting the monitored first traffic volume subset based at least in part on the unit traffic value, a second amount of traffic units for boosting the monitored second traffic volume subset based at least in part on the unit traffic value, a third amount of traffic units to be directed to the first sub-platform if the monitored first traffic volume subset does not meet the first target traffic volume by the predetermined time, and a fourth amount of traffic units to be directed to the second sub-platform if the monitored second traffic volume subset does not meet the second target traffic volume by the predetermined time. In response to determining a difference between the first and third amounts of traffic units outweighs a difference between the second and fourth amounts of traffic units, the one or more servers may be further configured to direct the first amount of traffic units to the first sub-platform and not redirect the second amount of traffic units to the second sub-platform.

In some embodiments, the one or more servers may be configured to minimize the first, second, third, and fourth traffic units based at least in part on the unit traffic value. The online traffic dynamical adjustment and optimization method may be implemented across the plurality of sub-platforms to minimize a total cost of the first, second, third, and fourth traffic units to the online platform.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an example environment for traffic control in online platform, in accordance with various embodiments.

FIGS. 2A-2F illustrate example systems for traffic control in online platform, in accordance with various embodiments.

FIG. 3 illustrates an example method for traffic control in online platform, in accordance with various embodiments.

FIGS. 4A-4B illustrate another example method for traffic control in online platform, in accordance with various embodiments.

FIG. 5 illustrates a block diagram of an example computer system in which any of the embodiments described herein may be implemented.

### DETAILED DESCRIPTION

Internet traffic control is important to the operation of many online platforms. The traffic flow, whether to the platform or among various sub-platforms of the platform, has a significant impact to the platform performance. For example, many sellers nowadays conduct online sales through sub-platforms of hosting platforms. From time to time, the hosting platform may organize sales events, such as Black Friday sales for online shoppers. These sales events often attract a huge volume of online traffic to visit the platform and usually many of the sub-platforms, bringing potential sales surge to the sellers. Nevertheless, not every seller benefits from these events. To participate, each seller has to pay a fee to the hosting platform and/or offer substantial sales discounts to customers. Further, as the sellers stocks up their inventories, they are exposed to the risk of receiving a tepid customer response and suffering loss. Since the number of sub-platforms in an online platform may be well over thousands or millions, it is challenging to automatically and dynamically optimize the traffic flow among the sub-platforms to minimize the potential loss to the sellers at the lowest expense to the hosting platform.

Various embodiments described below can overcome the problems arising in the realm of online traffic dynamical adjustment and optimization. In various implementations, an online traffic dynamical adjustment and optimization system may comprise one or more servers configured to monitor an incoming traffic volume for visiting an online platform, determine one or more unit traffic values of the monitored incoming traffic volume to the online platform based at least in part on at least one of a channel of the visit, a user set associated with the traffic, or a time of the visit, and monitor one or more subsets of the incoming traffic volume for respectively visiting one or more sub-platforms of the online platform. For a sub-platform, for which a traffic volume subset is monitored, the one or more servers may be further configured to determine a target traffic volume by a predetermined time, determine if the traffic volume subset will meet the target traffic volume by the predetermined time, in response to determining that the traffic volume subset will not meet the target traffic volume by the predetermined time, determine a first amount of traffic units for boosting the traffic volume subset based at least in part on the unit traffic value, and direct the first amount of traffic units to the corresponding sub-platform.

In some embodiments, an online traffic dynamical adjustment and optimization system may comprise one or more servers configured to monitor an incoming traffic volume for visiting an online platform and determine one or more unit traffic values of the monitored incoming traffic volume to the online platform based at least in part on at least one of a channel of the visit, a user set associated with the traffic, or a time of the visit. For each of a plurality of sub-platforms of the online platform, the plurality of sub-platform comprising one or more first sub-platforms and one or more second sub-platforms, the one or more servers may be further configured to monitor a first subset of the incoming traffic volume for visiting the first sub-platform and a second subset of the incoming traffic volume for visiting the second sub-platform, determine a first target traffic volume for the first sub-platform by a predetermined time based at least in part on the monitored first subset, determine a second target traffic volume for the second sub-platform by the predetermined time based at least in part on the monitored second subset, determine if the monitored first subset will meet the first target traffic volume by the predetermined time, and determine if the monitored second subset will meet the second target traffic volume by the predetermined time.

In response to determining that the monitored first traffic volume subset will not meet the first target traffic volume by the predetermined time and the monitored second traffic volume subset will not meet the second target traffic volume by the predetermined time, the one or more servers may be further configured to determine a first amount of traffic units for boosting the monitored first traffic volume subset based at least in part on the unit traffic value, a second amount of traffic units for boosting the monitored second traffic volume subset based at least in part on the unit traffic value, a third amount of traffic units to be directed to the first sub-platform if the monitored first traffic volume subset does not meet the first target traffic volume by the predetermined time, and a fourth amount of traffic units to be directed to the second sub-platform if the monitored second traffic volume subset does not meet the second target traffic volume by the predetermined time. In response to determining a difference between the first and third amounts of traffic units outweighs a difference between the second and fourth amounts of traffic units, the one or more servers may be further configured to direct the first amount of traffic units to the first sub-platform and not redirect the second amount of traffic units to the second sub-platform.

As such, a platform can dynamically control the online traffic volume to the platform and sub-platforms to improve the seller experience by at least mitigating their risks for participating the sales events. Enabled by an automated process, the platform can monitor multiple sub-platforms and associated traffic flows, determine one or more sub-platforms to be assisted to achieve their target traffic volumes, and optimally allocate resources among the one or more sub-platforms at the lowest cost to the platform. Overall, at least some of the sub-platforms reduce their losses or even gain from the assistance of the online platform, thus the performance of the online platform is improved. Further, the assistance decisions are optimally, automatically, and dynamically made for the online platform, with minimization of the cost to the online platform.

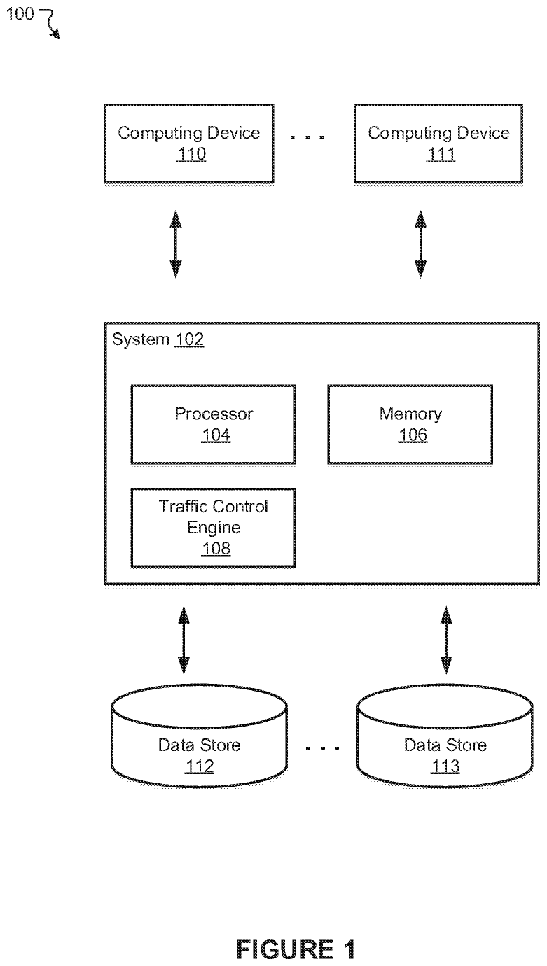

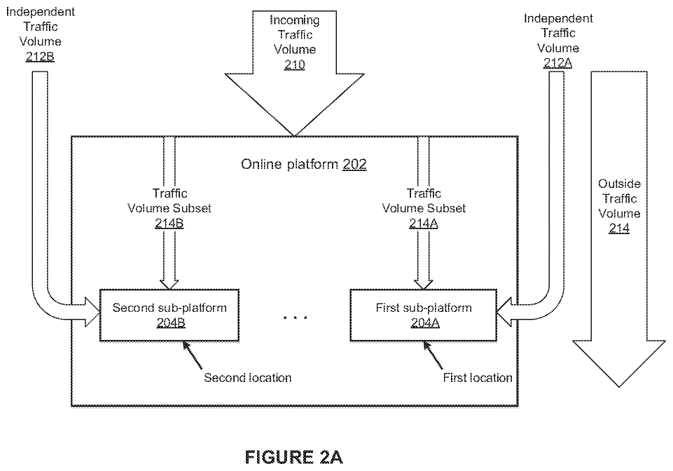

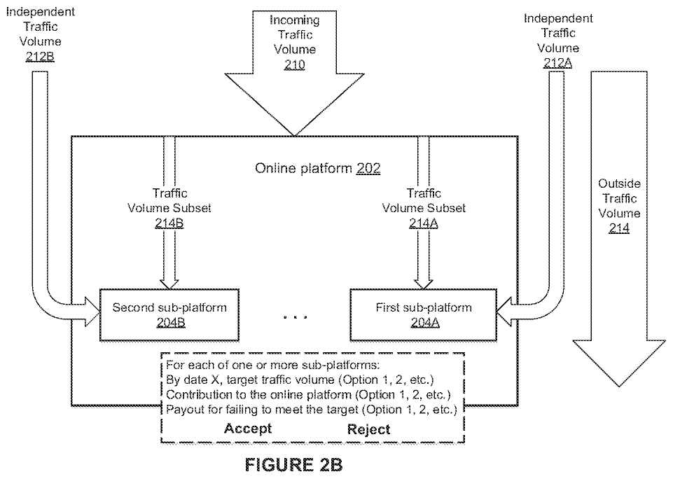

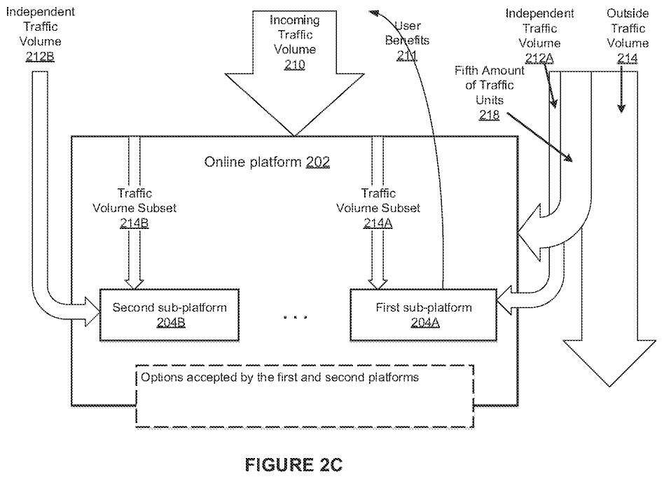

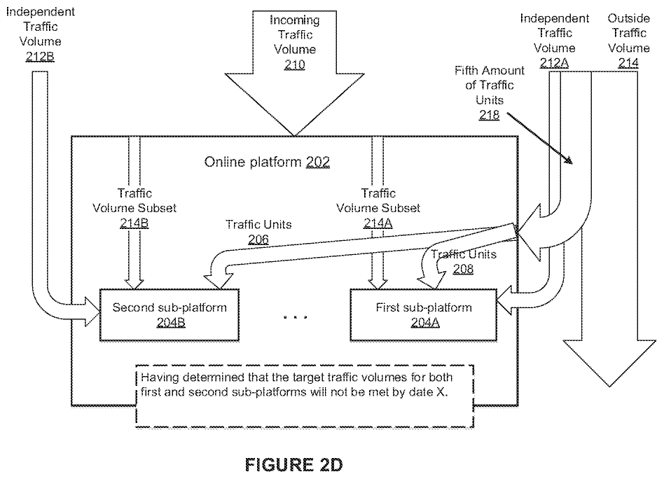

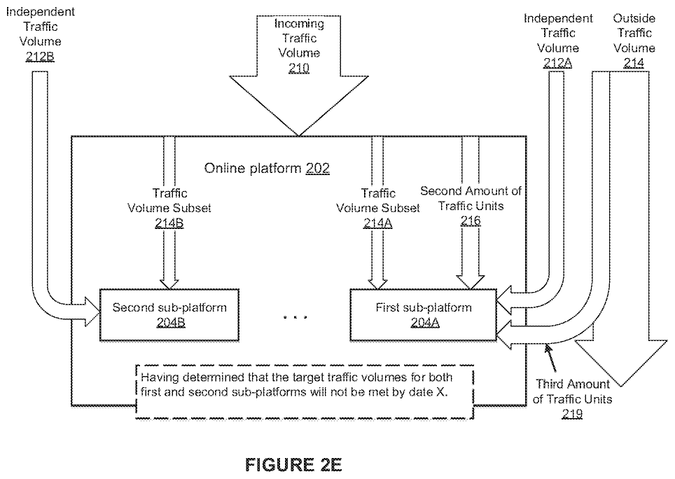

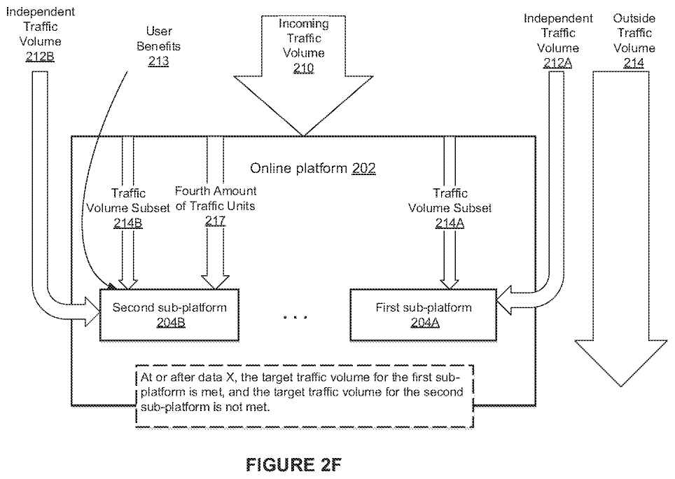

FIG. 1 illustrates an example environment 100 for traffic control in online platform, in accordance with various embodiments. As shown in FIG. 1, the example environment 100 can comprise at least one computing system 102 (e.g., server, computer, etc.) that includes one or more processors 104, memory 106, and traffic control engine 108. Although FIG. 1 depicts the traffic control engine 108 as a part of the system 102, the traffic control engine 108 may be alternatively disposed on a device (e.g., server, computer, etc.) coupled to the system 102. The memory 106 may be non-transitory and computer-readable. The memory 106 may store instructions (or algorithms) that, when executed by the one or more processors 104, cause the one or more processors 104 and/or the traffic control engine 108 to perform various operations described herein. The instructions (or algorithms) are described below with reference to FIGS. 2A-2F, FIG. 3, and FIGS. 4A-5B.

The environment 100 may include one or more computing devices (e.g., computing devices 110 and 111) and one or more data stores (e.g., data stores 112 and 113) that are accessible to the system 102. In general, the system 102, the computing device, and the data stores may be able to communicate externally or internally with one another through one or more wired or wireless networks (e.g., the Internet) through which data can be communicated. In some embodiments, the system 102 may be a server and the computing devices 110 and 111 may include mobile devices, tablets, computers, wearable devices, etc. The memory 106 and/or the data stores 112 and 113 may each include one or more databases to store various data needed for traffic control.

In some implementations, the system 102 may implement a platform and one or more associated sub-platforms online. The computing devices may manage and/or visit the platform and the sub-platforms. For example, a seller may manage a sub-platform as a virtual store for selling goods or services (both of which may be referred to as an “item” herein) via a computing device, and a buyer may visit the sub-platform via another computing device. The system 102 may monitor such online visit and store associated information of the visit in the memory 106 and/or the data stores 112 and 113, such as a channel of the visit, a display position of a sub-platform, a user set associated with the traffic, a time of the visit, etc. The channel of the visit may be associated with the device of the visit (e.g., via cellphone, tablet, computer, specific brand of cellphones, etc.) and/or with the method of the visit (e.g., via search engine results, direct link address, third-party recommendation, etc.). The display position of a sub-platform may be a position of the sub-platform or a position of a link to the sub-platform within the platform (e.g., platform level pop-up, display slot on platform landing page, top ten recommended links shown in platform subscriber emails, sub-menu mid-page banner, etc.). The user set associated with the traffic may include user of various demographics (e.g., young workers, students, working class, elderly, female users, metro area users, overseas users, users of region X, etc.). The time of the visit may be a time in a day, a weeks, a month, a year, etc.

FIGS. 2A-2F illustrate example systems for traffic control in online platform, in accordance with various embodiments. The operations shown in FIGS. 2A-2F and presented below are intended to be illustrative. The operations shown in FIGS. 2A-2F and presented below can be implemented by one or more components (e.g., processor 104, memory 106, and/or traffic control engine 108) of the system 102 described above. As shown in FIG. 2A, the system 102 may provide an online platform 202 and one or more sub-platforms including a first sub-platform 204A and a second sub-platform 204B. An online platform (e.g., the platform 202) may be implemented in various forms, such as website, Application (e.g., mobile software application), program (e.g., plug-in of a software or Application), etc. Correspondingly, sub-platforms (e.g., sub-platforms 204A and 204B) of the online platform may be implemented as webpages, webpage sections, Application pages, Application sections, etc. In one example, the platform 202 may implemented as an e-commerce website, and the sub-platforms 204A and 204B may be implemented as virtual stores available through various webpages of the e-commerce website. The sub-platforms may be provided at various locations of the online platform 202 (e.g., the first sub-platform 204A corresponds to a first location, the second sub-platform 204B corresponds to a second location, and both locations may be on the same or different webpages). The sub-platforms may be fully provided (e.g., shown on a webpage), partially provided (e.g., one item on sale by the sub-platform is shown on a webpage), or provided as links (e.g., URL links, QR code links, text or graphic descriptions, etc.) at the various locations. The location of a sub-platform or a link thereof may be, for example, within the of platform (e.g., in a platform level pop-up, at top display of a platform landing page, in a platform sub-menu mid-page banner, etc.) or within a rendering associated with the platform (e.g., in top ten recommended links in a platform subscriber email, appended to a search engine result of the online platform, etc.).

In some embodiments, various computing devices may visit the online platform 210, the first sub-platform 204A, and/or the second sub-platform 204B, forming traffic volumes shown in FIG. 2A. For example, internet visits to the online platform 202 may be shown as incoming traffic volume 210. The incoming traffic volume 210 may be linked to, be redirected to, or otherwise land at the sub-platforms. For example, a subset for the incoming traffic volume 210 (traffic volume subset 214A) may reach the first sub-platform 204A, and another subset for the incoming traffic volume 210 (traffic volume subset 214B) may reach the second sub-platform 204B. Further, some internet traffic volume may be linked to, be redirected to, or otherwise land at the sub-platforms without first reaching the online platform 202. For example, independent traffic volume associated with a search engine result or a third-party recommendation may link to a sub-platform. With that regard, independent traffic volume 212A may reach the first sub-platform 204A, and independent traffic volume 2128 may reach the second sub-platform 204B. In addition, outside traffic volume 214 may be currently unrelated to the platform and sub-platforms.

In some embodiments, the system 102 may monitor the incoming traffic volume 210 for visiting the online platform 202, determine one or more unit traffic values of the monitored incoming traffic volume to the online platform 202, and monitor one or more subsets of the incoming traffic volume for respectively visiting the sub-platforms (e.g., the first sub-platform 204A and the second sub-platform 204B) of the online platform. The “unit traffic value” can refer to a unit value of online traffic with respect to an entity. In a simplest example, if an online store receives 1000 online visits and generates 1000 dollar profits each day, the unit traffic value for this online store can be 1 dollar/visit. The unit traffic value may be determined for the online platform 202 and/or one or more of the sub-platforms. The unit traffic value for the online platform 202 (represented by Val_{traffic}) may be determined based at least in part on various factors, such as a channel of the visit (represented by channel), a user set associated with the traffic (represented by uv), a location of the sub-platform or of a link to the sub-platform in the online platform 202 (represented by res), a time of the visit (represented by t), etc. The unit traffic valuation can be further determined as:

Val_{traffic}(channel, res, uv, t)=ƒ(gmv, click, imp, cart, fav, . . . )

In this example, ƒ represents a function. gmv represents normalized gross merchandise volume created by a certain traffic unit at a certain time window at given channel, res, uv, and t. click represents a normalized quantity of clicks created by the certain traffic unit at the certain time window at the given channel, res, uv, and t. imp represents a normalized quantity of impression created by the certain traffic unit at the certain time window at the given channel, res, uv, and t. cart represents a normalized quantitative description of adding items or goods to cart created by the certain traffic unit at the certain time window at the given channel, res, uv, and t. fav represents a normalized quantitative description of behavior of saving items or goods to favorite created by the certain traffic unit at the certain time window at the given channel, res, uv, and t. The function ƒ may include more or fewer parameters than those described above. In this disclosure, the “traffic unit” and various amounts of “traffic units” described below can refer to internet traffic volumes with respect to an entity. The “traffic units” can be monitored or unmonitored, controlled or uncontrolled, etc. In an example, an online store may pay a search engine to endorse links to the online store, such that links to the online store can be displayed to catch users' attention when some terms are searched from the search engine. The internet traffic to the online store caused by links on the search engine creates a certain amount of traffic units. Similarly, the traffic units can be categorized based on the channel, time, device, and/or many other factors.

There may be various functions for obtaining the unit traffic value. In a specific example, the unit traffic value can be:

Val_{traffric}(channel, res, uv, t)=C1×gmv+C2×click+C3×imp+C4×cart+C5×fav,

where C1, C2, C3, C4, and C5 are coefficients at the given channel, res, uv, and t. The coefficients may be trained by various machine learning methods, such as regression, decision tree, neural network, etc. For example, historical Val, gmv, click, imp, cart, and fav values can be fitted regressively to obtain the coefficients C1, C2, C3, C4, and C5 at various confidence levels.

For a sub-platform, for which a traffic volume subset is monitored, the system 102 may determine a target traffic volume by a predetermined time. In some embodiments, to determine the target traffic volume by the predetermined time, the one or more servers are configured to determine the target traffic volume by the end of a fixed time period. The incoming traffic volume for visiting the online platform may increase during the fixed time period. For example, the fixed time period may be one or more days in a year during which the online platform 202 hosts a sales event, and the sales event attracts significantly more than usual internet traffic to the online platform 202. The predetermined time may be the end of the sales event, e.g., at a certain time of a certain date.

To determine the target traffic volume by the predetermined time, the one or more servers are configured to determine the target traffic volume by the predetermined time based at least in part on the traffic volume subset of the sub-platform, for which the traffic volume subset is monitored. The target traffic volume may be determined based on various classification and regression methods, such as a Gradient Boosted Regression Tree model with outlier removal. A person skilled in the art would understand the application of the Gradient Boosted Regression Tree model to map observations about an item (e.g., past traffic volume) to conclusions of the item's target value (e.g., future traffic volume). Through training with the positive samples (e.g., correct predictions) and negative samples (e.g., wrong predictions), the trained tree model can accurately predict a future traffic volume, based on which the system 102 can determine the target traffic volume.

To participate the sales event or otherwise share the benefits of the surge in traffic to the online platform 202, the sub-platforms may make a contribution to the online platform 202. Further, before the end of the predetermined time, the system 102 may offer the operators (e.g., sellers) associated with the sub-platforms various options to at least mitigate their risk of suffering losses from participating the sales event.

The exemplary platform and sub-platform configuration and traffic volumes shown in FIG. 2A are carried over in FIGS. 2B-2F, where additional conditions, features, functions, or traffic volumes are illustrated. As shown in FIG. 2B, the system 102 may provide various options respectively to one or more of the sub-platforms. The options may include a target traffic volume to be achieved by a certain time (e.g., during certain preset days), a contribution to the online platform for accepting the option, and a payout to the sub-platform if the target is not met. The target traffic volume may be associated with the sub-platform or an item on sale at the sub-platform. The traffic volume may be associated with a sales volume or sales amount of one or more items at the sub-platform.

Further, various target traffic volumes each associated with various contribution and payout combinations may be offered as the options. An operator associated with the sub-platform may select and accept an option including a target traffic volume, an associated contribution, and an associated payout. In some embodiments, the target traffic or real volume may correspond to (e.g., be proportional to) a target or real sales of an item at the sub-platform.

There may be various methods for determining the contribution and payout. In some embodiments, the system 102 may determine the contribution based at least in part on: the unit traffic value, the first amount of traffic units, the sub-platform and the associated item, the number of sub-platforms and the associated items, the target traffic volume, the confidence level of the predicted traffic volume, the payout (e.g., the fourth amount of traffic units) and associated variance, etc. The system 102 may determine the contribution based at least in part on a Bernstein Inequality. The contribution and payout may be associated with a specific item i of a sub-platform (e.g., a laptop on sale at a sub-platform). With Xᵢ being the sales of the item i (the sales being proportional to a traffic volume), the contribution qᵢ and the payout Yᵢ=ƒ)Xᵢ) can be determined based on:

P(ΣᵢnᵢYᵢ≥Σᵢnᵢqᵢ)≤δ

In this example, nᵢ is the quantity of options that a sub-platform purchases for item i, and δ is the probability that the online platform suffers losses from accepting the option(s) and can be set to be a small value such as 0.01 or 0.05.

According to the Bernstein Inequality and 1≤nᵢ≤Nᵢ, it can be obtained that:

$$P ( {\sum }_{i} {n}_{i} {Y}_{i} \geq {\sum }_{i} {n}_{i} {μ}_{i} + γ \sqrt{{\sum }_{i} {( {n}_{i} {σ}_{i} )}^{2}} + \frac{{γ}^{2} {max}_{i} {n}_{i} {b}_{i}}{3} ) \leq {e}^{- \frac{{ɛ}^{{*}^{2}}}{2 {{Σ}_{i} ( {n}_{i} {σ}_{i} )}^{2} + \frac{2}{3} {ɛ}^{*} b}}$$

In this example, μᵢ=EYᵢ is the mean of the payout, σᵢ²=E(Yᵢ−μᵢ)² is the variance of the payout. bᵢ=sup(Yᵢ−μᵢ) is the maximum possible payout. The payout may be related to the unit traffic value. ϵ* is the result from the Bernstein inequality. The power of the exponential is:

$$- \frac{{ϵ}^{{*}^{2}}}{2 {{Σ}_{i} ( {n}_{i} {σ}_{i} )}^{2} + \frac{2}{3} {ϵ}^{*} b} = - \frac{{γ}^{2} {{Σ}_{i} ( {n}_{i} {σ}_{i} )}^{2} + \frac{2}{3} {γ}^{3} b \sqrt{{{Σ}_{i} ( {n}_{i} {σ}_{i} )}^{2}} + \frac{{γ}^{4} {b}^{2}}{9}}{2 {{Σ}_{i} ( {n}_{i} {σ}_{i} )}^{2} + \frac{2}{3} γ b \sqrt{{{Σ}_{i} ( {n}_{i} {σ}_{i} )}^{2}} + \frac{2 {γ}^{2} {b}^{2}}{9}} \leq - \frac{{γ}^{2} {{Σ}_{i} ( {n}_{i} {σ}_{i} )}^{2} + \frac{1}{3} {γ}^{3} b \sqrt{{{Σ}_{i} ( {n}_{i} {σ}_{i} )}^{2}} + \frac{{γ}^{4} {b}^{2}}{9}}{2 {{Σ}_{i} ( {n}_{i} {σ}_{i} )}^{2} + \frac{2}{3} γ b \sqrt{{{Σ}_{i} ( {n}_{i} {σ}_{i} )}^{2}} + \frac{2 {γ}^{2} {b}^{2}}{9}} = - \frac{{γ}^{2}}{2}$$

With e^{-γ}^{²}^{/2}=δ, it can be obtained that:

$${q}_{i} = {μ}_{i} + \frac{γ {N}_{i} {σ}_{i}^{2}}{\sqrt{m {σ}^{2}}} + \frac{{γ}^{2} ( {max}_{i} {N}_{i} {b}_{i} ) {N}_{i} {b}_{i}}{3 mb}$$

In this example, mσ²=ΣᵢNᵢσᵢ² and mb=ΣᵢNᵢbᵢ. Since m is the total number of items, the average variance and possible (average) maximum payout can be obtained from the above equations. Thus, according to the Bernstein inequality, the probability of the online platform suffering losses from accepting the options can be limited, and the contribution qᵢ can be derived.

The contribution and payout may be made as an amount of traffic units, user benefits, monetary payment, or a combination thereof. The traffic units may be valued as described above. In some embodiments, for the first sub-platform 204A, for which the traffic volume subset 214A is monitored, the system 102 may determine the amount of user benefits based at least in part on at least one of a number of users receiving the user benefits (represented by Nᵢₙ^{s}), a gross merchandise volume associated with users applying the user benefits (represented by Gᵢₙ^{s}), a number of users not receiving the user benefits (represented by Nₒᵤₜ^{s}), a gross merchandise volume associated with users not applying the user benefits (represented by Gₒᵤₜ^{s}), or a total value associated with the user benefits (represented by C).

In some embodiments, the system 102 may determine the user benefit equivalent of traffic units based on the unit traffic value Val_{traffic} determination described above and a determination of the user benefits value (represented by fₛ) according to:

$${f}_{s} = ( \frac{{G}_{in}^{s}}{{N}_{in}^{s}} - \frac{{G}_{out}^{s}}{{N}_{out}^{s}} ) \text{/} C$$

Referring to FIG. 2C, an option associated with a contribution and a payout may be accepted by the first sub-platform 204A. The contribution may be made before or after the predetermined time described above. In some embodiments, the first sub-platform 204A may direct a fifth amount of traffic units 218 outside the incoming traffic volume 210 to the online platform 202 and/or issue an amount of user benefits 211 to the online platform 202. The fifth amount of traffic units 218 may comprise a part of the independent traffic volume 212A and/or a part of the outside traffic volume 214. For example, a part of the independent traffic volume 212A (described above) originally sponsored by the first sub-platform 204A and directed to the first sub-platform 204A may be diverted to the online platform 202 (e.g., by changing the link address to point to the online platform, etc.). The sub-platform 204A may also purchase some outside traffic volume 214 to direct to the online platform 202 (e.g., by sponsoring advertisement to point to the online platform, sponsoring search result links to point to the online platform, etc.). The first sub-platform 204A may also contribute and sponsor user benefits 211 (e.g., coupons, discounts, etc.) for distribution among users of the online platform 202. Though not shown in FIG. 2C, the second sub-platform may make a similar contribution to the online platform 202.

With the option accepted by the sub-platforms, the system 102 may keep monitoring the traffic flow associated with the sub-platforms and make predictions based on the monitored information, regardless whether obtained before or after the acceptance. In some embodiments, the system 102 may determine if the monitored traffic volume subset will meet the target traffic volume by the predetermined time described above with reference to FIG. 2A. If the system 102 determines that the monitored traffic volume subset will meet the target traffic volume by the predetermined time, the system 102 may not implement further steps, because the expectation of the corresponding sub-platform operator (e.g., a target sales volume or sales amount proportional to the monitored traffic volume subset) will be met. In the following embodiments, both the first sub-platform 204A and the second sub-platform 204B accepted their respective target traffic volumes, and the system 102 may determine that neither of the target traffic volumes will be met by the predetermined time.

In response to determining that the traffic volume subset(s) will not meet the target traffic volume(s) by the predetermined time, the system 102 may determine various strategies to achieve the best outcome with the least expense. The system 102 may monitor multiple sub-platforms (e.g., all sub-platforms of the online platform 202) and determine the strategies based on their target traffic volumes, contributions, and payouts. The strategies may include, for example, spending resources to meet the target traffic volumes for one or more, but not necessarily all, of the sub-platforms that are projected to fall short of their target traffic volumes. The strategies may be subject to minimizing the cost to the online platform, which may include the cost of directing traffic units, whether outside or within the online platform, to the sub-platforms. In some embodiments, the optimization may be expressed as minimizing a total cost to the online platform over n sub-platforms m:

$${min}_{{m}_{i}} {\sum }_{i = 1}^{n} g ( f ( {m}_{i} ) , {m}_{i} ) + {\sum }_{i = 1}^{n} {θ}_{i} ( \frac{{{C}_{i} [ {Y}_{0}^{i} - f ( {m}_{i} ) ]}_{+}}{{Y}_{0}^{i} {p}_{i}} ) + {\sum }_{i = 1}^{n} {ζ}_{i} {Z}_{i} subject to \frac{1}{n} {\sum }_{i = 1}^{n} {I}_{\{ f ( {m}_{i} ) \geq {Y}_{0}^{i} \}} \geq {δ}_{0} ,$$

where ƒ(mᵢ) represents the sales of sub-platform i when contributing mᵢ user benefits to the online platform (e.g., the sales being proportional to a traffic volume), g(ƒ(mᵢ), mᵢ) represents the cost to the sub-platform i when the sub-platform i contributing mᵢ user benefits to the online platform and receiving ƒ(mᵢ) sales, Y₀ⁱ represents the target sales for the sub-platform i (e.g., the target sales being proportional to the target traffic volume), pᵢ represents the contribution to the online platform from the sub-platform i, Cᵢ represents the contribution in dollar amount that sub-platforms i makes to the online platform,θᵢ is the cost to the online platform to compensate one traffic unit, δ₀ is a required ratio of sub-platforms achieving the target sales among those predicted to miss the target sales (the sales being proportional to a traffic volume). The notation [x]₊ equals to x when x is larger than 0, and otherwise equals to 0. I_{F(x)} is an indicator function that equals to 1 when F(x)>0, and otherwise equals to 0. ζᵢ is a normalized unit cost to the online platform when the online platform introduces additional traffic units to sub-platform i, whether the additional traffic units coming from outside or inside the online platform. Zᵢ is the amount of traffic units introduced from the online platform to a sub-platform i, whether the additional traffic units coming from outside or inside the online platform.

To help achieve the target traffic volume, the system 102 may determine a first amount of traffic units for boosting the traffic volume subset based at least in part on the unit traffic value, and direct the first amount of traffic units to the corresponding sub-platform. For example, as shown in FIG. 2D, for the first sub-platform 204A, for which the traffic volume subset 214A is monitored, the system 102 may receive the fifth amount of traffic units 218 (described above with reference to FIG. 2C) associated with the first sub-platform 204A, and may direct at least a part of the fifth amount of traffic units 218 to the first sub-platform 204A (e.g., traffic units 208) and/or the second sub-platform 204B (e.g., traffic units 206). Directing the traffic units 208 to the first sub-platform 204A and the traffic units 206 to the second sub-platform 204B may help the sub-platforms to achieve their target traffic volumes.

For another example, the system 102 may determine, based on the optimization described above, to help the first sub-platform to achieve its target traffic volume, while not help the second sub-platform. As shown in FIG. 2E, for the first sub-platform 204A, for which the traffic volume subset 214A is monitored, the system 102 may determine a first amount of traffic units for boosting the traffic volume subset 214A based at least in part on the unit traffic value, and direct the first amount of traffic units to the first sub-platform 204A. The first amount of traffic units may include a second amount of traffic units 216 and/or a third amount of traffic units 219. The system 102 may obtain a part of the incoming traffic volume 210 other than the traffic volume subset 214A as the second amount of traffic units 216, and obtain the third amount of traffic units 219 from the outside traffic volume 214. The unit traffic value of the incoming traffic volume 210 and the amount of traffic units (e.g., the first, second, and third amounts of traffic units) can be multiplied to indicate the cost of traffic units to the online platform, as incorporated in the optimization described above, and be used to determine if the online platform should assist the corresponding sub-platform to achieve its target traffic volume.

In some implementations, the system 102 may direct the second amount of traffic units 216 to the first sub-platform 204A by various methods. The system 102 may create a link to the first sub-platform, display the link at prime locations (e.g., front page of the online platform, platform-wide pop-up, main page banner, etc.), provide more display slots of the sub-platform or an associated link, extend display time of the sub-platform or an associated link, etc. The prime locations may be those frequently visited by users of the online platform, such that a link to the sub-platform at the prime location is likely to attract clicks on the link to visit the sub-platform. Further, the system 102 may divert some links originally linked to the online platform 202 to the first sub-platform 204A. For example, some of incoming traffic volume 210 may originate from links sponsored by the online platform 202, and the system 102 may alter the original link to point to the first sub-platform 204A or augment a link to the first sub-platform 204A to the original link.

In some implementations, the system 102 may obtain a part of the outside traffic volume 214 as the third amount of traffic units 219 to direct to the first sub-platform 204A. For example, the system 102 may sponsor a link to the first sub-platform 204A. The link may be associated with an online third-party (e.g., a link shown on a popular blog), a search engine result (e.g., a link appended to a key word search result of the sub-platform or of the sales event), etc. The link may comprises many forms, such as a URL link, a QR code link, a text or graphic description, or a link that can otherwise be associated with the sub-platform. The description of the link can be similarly applied to other parts of the disclosure for bringing in traffic volume. For another example, the system 102 may sponsor a ranking, search, or commendation result of the first sub-platform (e.g., by increasing the search score of the first sub-platform, when the online platform is searched and various sub-platforms related to the online platform are generated in response to the search).

In some embodiments, the payout may be made by the online platform to the sub-platform, if the target traffic volume for the sub-platform is not met by the predetermined date. Otherwise, no payout is made. As shown in FIG. 2F (where the target traffic volume for the first sub-platform is met and that for the second sub-platform is not met), for the second sub-platform 204B, for which the traffic volume subset 214B is monitored, the system 102 may determine a fourth amount of traffic units 217 based at least in part on the unit traffic value Val_{traffic}, and in response to detecting, at or after the predetermined time, that the traffic volume subset for the second sub-platform did not meet the target traffic volume, direct the fourth amount of traffic units 217 to the second sub-platform 204B. The unit traffic value Val_{traffic} and the fourth amount of traffic units may match the payout. The fourth amount of traffic units 217 may be made to the second sub-platform 204B as its payout. Alternatively or as a combination with the fourth amount of traffic units, the system 102 may direct a user benefits 213 and/or make a monetary payout to the second sub-platform 204B. The user benefits 213 may be sponsored by the online platform 202 to be used by the second sub-platform 204B. The operator may determine to execute the fourth amount of traffic units 217 and/or the user benefits 213 any time. No fourth amount of traffic units needs to be made to the first sub-platform 204A, because with the assistance of from the online platform described above, its target sales volume has been met.

In this example, the payout to the second sub-platform and the cost to assist the first sub-platform are the total cost to the online-platform, which may be determined to be (1) less than the payout to the second sub-platform and the payout to the first sub-platform (for assisting neither sub-platform), (2) less than the cost to assist the first and second sub-platforms to achieve their target traffic volumes (for assisting both sub-platforms), and (3) also less than less than the payout to the first sub-platform and the cost to assist the second sub-platform (for assisting the second sub-platform only). Nevertheless, the optimization process may end up assisting all sub-platforms or none sub-platform. Applying the same optimization to more sub-platforms, similar results can be obtained at the least cost to the online platform.

As such, the online platform can automatically and dynamically (e.g., daily, hourly, or in real-time) control traffic flow to various sub-platforms to at least mitigate the risk for not receiving the expected online traffic volumes to the sub-platforms. The online platform may control the traffic flow with the optimization of overall gain to the online platform. Based on known contributions from the sub-platforms, accepted payouts for missing the target traffic volumes, and the amount of resources at the disposal of the online platform, the online platform can determine the optimized allocation of the resources, for example, to help selected sub-platforms to achieve the target traffic volumes.

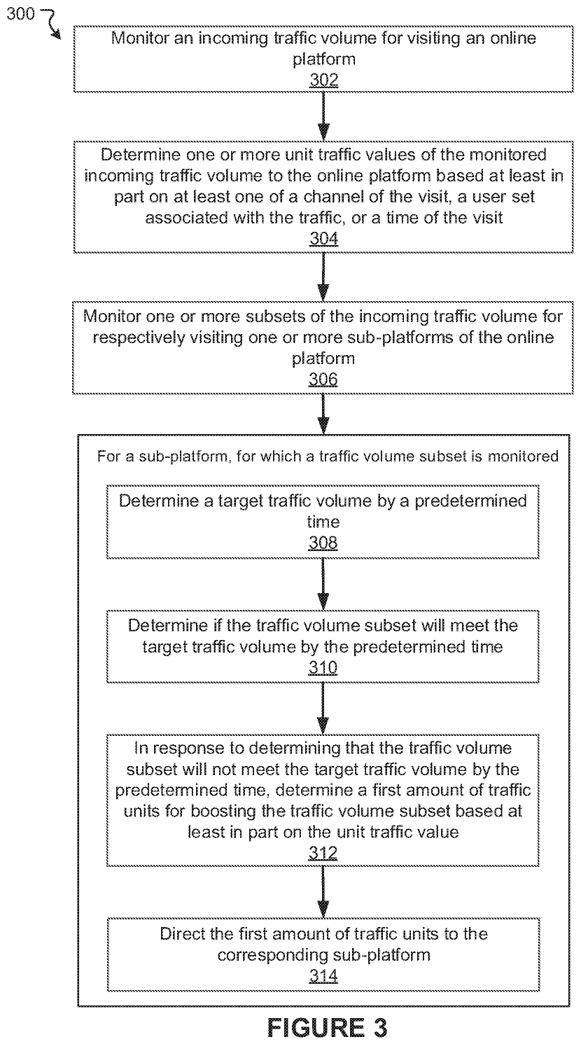

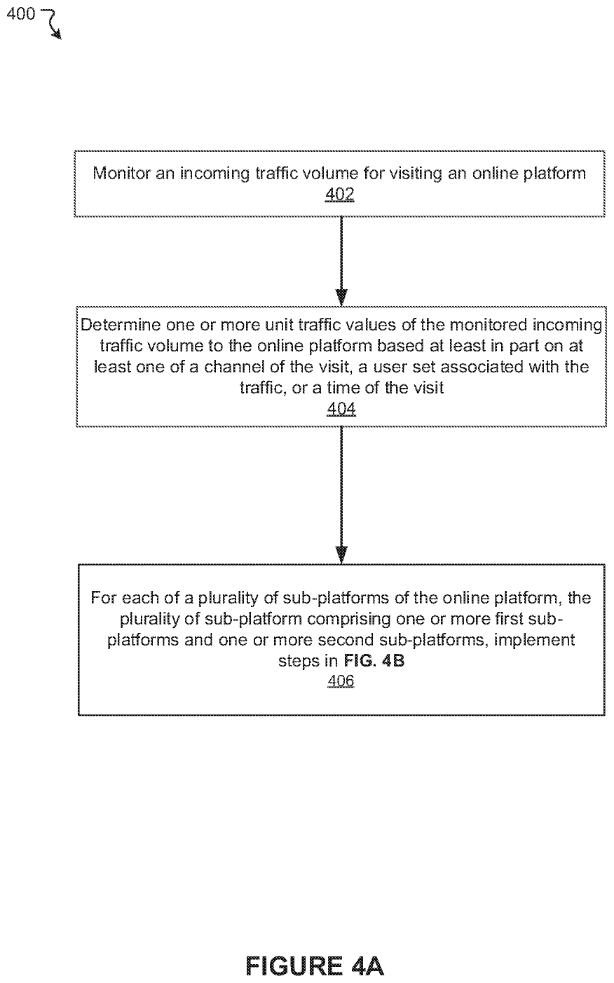

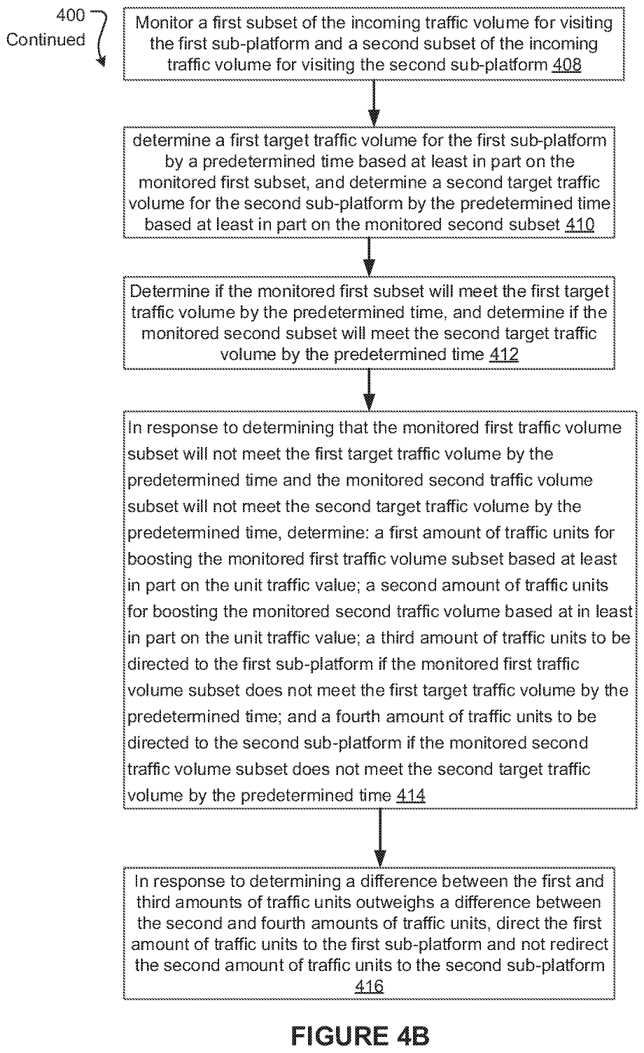

FIG. 3 and FIGS. 4A-4B illustrate flowcharts of example methods for traffic control in online platform corresponding to the descriptions of FIGS. 2A-2F, according to various embodiments of the present disclosure. FIG. 3 illustrates a flowchart of an example method 300 for traffic control in online platform, according to various embodiments of the present disclosure. The method 300 may be implemented in various environments including, for example, the environment 100 of FIG. 1. The operations of method 300 presented below are intended to be illustrative. Depending on the implementation, the example method 300 may include additional, fewer, or alternative steps performed in various orders or in parallel. The example method 300 may be implemented in various computing systems or devices (e.g., processor and/or traffic control unit of the system 102, one or more servers, etc.).

At block 302, an incoming traffic volume for visiting an online platform may be monitored. At block 304, one or more unit traffic values of the monitored incoming traffic volume to the online platform may be determined based at least in part on at least one of a channel of the visit, a user set associated with the traffic, or a time of the visit. At block 306, one or more subsets of the incoming traffic volume for respectively visiting one or more sub-platforms of the online platform may be monitored. For a sub-platform, for which a traffic volume subset is monitored, blocks 308-314 may be implemented. At block 308, a target traffic volume by a predetermined time may be determined. At block 310, it may be determined if the traffic volume subset will meet the target traffic volume by the predetermined time. At block 312, in response to determining that the traffic volume subset will not meet the target traffic volume by the predetermined time, a first amount of traffic units may be determined for boosting the traffic volume subset based at least in part on the unit traffic value. At block 314, the first amount of traffic units may be directed to the corresponding sub-platform.

FIGS. 4A-4B illustrate flowcharts of an example method 400 for traffic control in online platform, according to various embodiments of the present disclosure. The method 400 may be implemented in various environments including, for example, the environment 100 of FIG. 1. The operations of method 400 presented below are intended to be illustrative. Depending on the implementation, the example method 400 may include additional, fewer, or alternative steps performed in various orders or in parallel. The example method 400 may be implemented in various computing systems or devices (e.g., processor and/or traffic control unit of the system 102, one or more servers, etc.).

FIG. 4A illustrates blocks 402-406 of the example method 400. At block 402, an incoming traffic volume for visiting an online platform may be monitored. At block 404, one or more unit traffic values of the monitored incoming traffic volume to the online platform may be determined based at least in part on at least one of a channel of the visit, a user set associated with the traffic, or a time of the visit. At block 406, for each of a plurality of sub-platforms of the online platform, the plurality of sub-platform comprising one or more first sub-platforms and one or more second sub-platforms, steps in FIG. 4B may be implemented.

FIG. 4B illustrates blocks 408-416 of the example method 400. At block 408, a first subset of the incoming traffic volume for visiting the first sub-platform and a second subset of the incoming traffic volume for visiting the second sub-platform may be monitored. At block 410, a first target traffic volume for the first sub-platform by a predetermined time may be determined based at least in part on the monitored first subset, and a second target traffic volume for the second sub-platform by the predetermined time may be determined based at least in part on the monitored second subset. At block 412, it may be determined if the monitored first subset will meet the first target traffic volume by the predetermined time, and if the monitored second subset will meet the second target traffic volume by the predetermined time. At block 414, in response to determining that the monitored first traffic volume subset will not meet the first target traffic volume by the predetermined time and the monitored second traffic volume subset will not meet the second target traffic volume by the predetermined time, various amounts of traffic units may be determined. A first amount of traffic units for boosting the monitored first traffic volume subset may be determined based at least in part on the unit traffic value. A second amount of traffic units for boosting the monitored second traffic volume subset based at least in part on the unit traffic value may be determined. A third amount of traffic units to be directed to the first sub-platform if the monitored first traffic volume subset does not meet the first target traffic volume by the predetermined time may be determined. A fourth amount of traffic units to be directed to the second sub-platform if the monitored second traffic volume subset does not meet the second target traffic volume by the predetermined time may be determined. At step 416, In response to determining a difference between the first and third amounts of traffic units outweighs a difference between the second and fourth amounts of traffic units, the first amount of traffic units may be directed to the first sub-platform, and the second amount of traffic units may not be directed to the second sub-platform.

In some embodiments, the online traffic dynamical adjustment and optimization method 400 may be implemented across a plurality of sub-platforms of an online platform to minimize a total cost of the first, second, third, and fourth traffic units to the online platform. The first, second, third, and fourth traffic units may be minimized based at least in part on the unit traffic value. For example, the values of the first, second, third, and fourth traffic units may be determined based on the unit traffic value, and the online platform's priority for boosting the traffic volumes may be given to sub-platforms with higher potential losses in values if missing the target traffic volumes.

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques. Computing device(s) are generally controlled and coordinated by operating system software. Conventional operating systems control and schedule computer processes for execution, perform memory management, provide file system, networking, I/O services, and provide a user interface functionality, such as a graphical user interface (“GUI”), among other things.

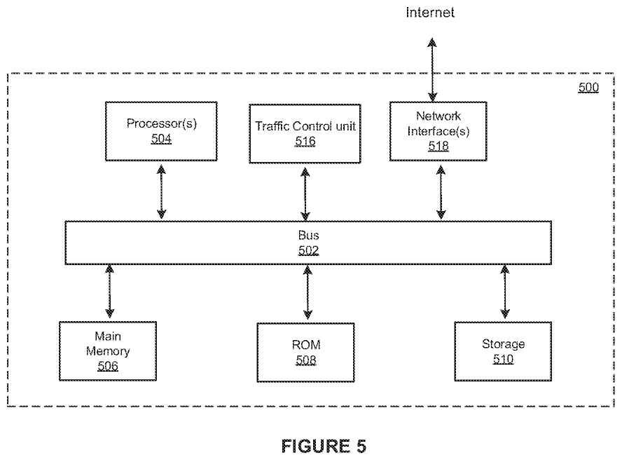

FIG. 5 is a block diagram that illustrates a computer system 500 upon which any of the embodiments described herein may be implemented. The system 500 may correspond to the system 102 described above. The computer system 500 includes a bus 502 or other communication mechanism for communicating information, one or more hardware processors 504 coupled with bus 502 for processing information. Hardware processor(s) 504 may be, for example, one or more general purpose microprocessors. The processor(s) 504 may correspond to the processor 104 described above.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions. The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions. The main memory 506, the ROM 508, and/or the storage 510 may correspond to the memory 106 described above.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The main memory 506, the ROM 508, and/or the storage 510 may include non-transitory storage media. The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 500 also includes a traffic control unit 516 coupled to bus 502. The traffic control unit 516 may correspond to the traffic control engine 108 described above. The traffic control unit 516 may be configured to effectuate traffic flow control, for example, by directing traffic volumes/traffic units to or away from a platform or sub-platform. The traffic control unit 516 may be implemented as software (e.g., online traffic redirecting instructions, sub-platform link displaying instructions, etc.), hardware (e.g., online traffic router, etc.), or a combination of both.

The computer system 500 also includes a communication interface 518 coupled to bus 502. Communication interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN (or WAN component to communicated with a WAN). Wireless links may also be implemented. In any such implementation, communication interface 518 sends and receives electrical, electromagnetic or optical signals that carry digital data streams representing various types of information.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of the example methods disclosed herein may be at least partially distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

The various operations of example methods described herein may be performed, at least partially, by one or more modules implemented by the system 500.

A module may refer to logic embodied in hardware or firmware, or to a collection of software instructions, possibly having entry and exit points, written in a programming language. A software module may be compiled and linked into an executable program, installed in a dynamic link library, or may be written in an interpreted programming language. The modules or computing device functionalities described herein are preferably implemented as software modules, but may be represented in hardware or firmware. Software modules configured for execution on computing devices may be provided on a computer readable medium, such as a compact disc, digital video disc, flash drive, magnetic disc, or any other tangible medium, or as a digital download. Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. An online traffic dynamical adjustment and optimization system, comprising:
one or more servers configured to:
monitor an incoming traffic volume for visiting an online platform;
determine one or more unit traffic values of the monitored incoming traffic volume to the online platform;
monitor one or more subsets of the incoming traffic volume for respectively visiting one or more sub-platforms of the online platform; and
for a sub-platform, for which a traffic volume subset is monitored:
determine a target traffic volume by a predetermined time;
determine if the traffic volume subset will meet the target traffic volume by the predetermined time;
in response to determining that the traffic volume subset will not meet the target traffic volume by the predetermined time, determine a first amount of traffic units for boosting the traffic volume subset based at least in part on the unit traffic value; and
direct the first amount of traffic units to the corresponding sub-platform.

2. The online traffic dynamical adjustment and optimization system of claim 1, wherein:
to determine the one or more unit traffic values of the monitored incoming traffic volume to the online platform, the one or more servers are configured to determine the one or more unit traffic values of the monitored incoming traffic volume to the online platform based at least in part on at least one of a channel of the visit, a user set associated with the traffic, or a time of the visit;
to determine the target traffic volume by the predetermined time, the one or more servers are configured to determine the target traffic volume by an end of a fixed time period;
to determine the target traffic volume by the predetermined time, the one or more servers are configured to determine the target traffic volume by the predetermined time based at least in part on the traffic volume subset of the sub-platform, for which the traffic volume subset is monitored; and
the incoming traffic volume for visiting the online platform increases during the fixed time period.

3. The online traffic dynamical adjustment and optimization system of claim 1, wherein:
the first amount of traffic units includes at least one of a second amount of traffic units or a third amount of traffic units; and
for the sub-platform, for which the traffic volume subset is monitored, the one or more servers are further configured to:
obtain the second amount of traffic units from the incoming traffic volume without the traffic volume subset to the corresponding sub-platform; and
obtain the third amount of traffic units from outside the incoming traffic volume.

4. The online traffic dynamical adjustment and optimization system of claim 1, wherein:
for the sub-platform, for which the traffic volume subset is monitored, the one or more servers are further configured to:
determine a fourth amount of traffic units based at least in part on the unit traffic value; and
in response to detecting, at or after the predetermined time, that the traffic volume subset did not meet the target traffic volume, direct the fourth amount of traffic units to the sub-platform.

5. The online traffic dynamical adjustment and optimization system of claim 4, wherein:
for the sub-platform, for which the traffic volume subset is monitored, the one or more servers are further configured to:
determine a contribution to be made to the online platform based at least in part on the unit traffic value.

6. The online traffic dynamical adjustment and optimization system of claim 5, wherein:
to determine the contribution to be made to the online platform, the one or more servers are configured to determine the contribution based at least in part on a Bernstein Inequality.

7. The online traffic dynamical adjustment and optimization system of claim 5, wherein:
the contribution comprises at least one of:
a fifth amount of traffic units outside the incoming traffic volume; or
an amount of user benefits.

8. The online traffic dynamical adjustment and optimization system of claim 7, wherein:
for the sub-platform, for which the traffic volume subset is monitored, the one or more servers are further configured to:
receive the fifth amount of traffic units associated with the sub-platform; and
direct at least a part of the received fifth amount of traffic units to another sub-platform.

9. The online traffic dynamical adjustment and optimization system of claim 7, wherein:
for the sub-platform, for which the traffic volume subset is monitored, the one or more servers are further configured to:
determine the amount of user benefits based at least in part on at least one of a number of users receiving the user benefits, a gross merchandise volume associated with users applying the user benefits, a number of users not receiving the user benefits, a gross merchandise volume associated with users not applying the user benefits, or a total value associated with the user benefits.

10. An online traffic dynamical adjustment and optimization method, comprising:
monitoring an incoming traffic volume for visiting an online platform;
determining one or more unit traffic values of the monitored incoming traffic volume to the online platform;
monitoring one or more subsets of the incoming traffic volume for respectively visiting one or more sub-platforms of the online platform; and
for a sub-platform, for which a traffic volume subset is monitored:
determining a target traffic volume by a predetermined time;
determining if the traffic volume subset will meet the target traffic volume by the predetermined time;
in response to determining that the traffic volume subset will not meet the target traffic volume by the predetermined time, determining a first amount of traffic units for boosting the traffic volume subset based at least in part on the unit traffic value; and
directing the first amount of traffic units to the corresponding sub-platform.

11. The online traffic dynamical adjustment and optimization method of claim 10, wherein:
determining the one or more unit traffic values of the monitored incoming traffic volume to the online platform comprises determining the one or more unit traffic values of the monitored incoming traffic volume to the online platform based at least in part on at least one of a channel of the visit, a user set associated with the traffic, or a time of the visit;
determining the target traffic volume by the predetermined time comprises determining the target traffic volume by an end of a fixed time period;
determining the target traffic volume by the predetermined time comprises determining the target traffic volume by the predetermined time based at least in part on the traffic volume subset of the sub-platform, for which the traffic volume subset is monitored; and
the incoming traffic volume for visiting the online platform increases during the fixed time period.

12. The online traffic dynamical adjustment and optimization method of claim 10, wherein:
the first amount of traffic units includes at least one of a second amount of traffic units or a third amount of traffic units; and
the method further comprises:
for the sub-platform, for which the traffic volume subset is monitored:
obtaining the second amount of traffic units from the incoming traffic volume without the traffic volume subset to the corresponding sub-platform; and
obtaining the third amount of traffic units from outside the incoming traffic volume.

13. The online traffic dynamical adjustment and optimization method of claim 10, further comprising:
for the sub-platform, for which the traffic volume subset is monitored:
determining a fourth amount of traffic units based at least in part on the unit traffic value; and
in response to detecting, at or after the predetermined time, that the traffic volume subset did not meet the target traffic volume, directing the fourth amount of traffic units to the sub-platform.

14. The online traffic dynamical adjustment and optimization method of claim 13, further comprising:
for the sub-platform, for which the traffic volume subset is monitored:
determining a contribution to be made to the online platform based at least in part on the unit traffic value.

15. The online traffic dynamical adjustment and optimization method of claim 14, wherein:
determining the contribution to be made to the online platform comprises determining the contribution based at least in part on a Bernstein Inequality.

16. The online traffic dynamical adjustment and optimization method of claim 14, wherein:
the contribution comprises at least one of:
a fifth amount of traffic units outside the incoming traffic volume; or
an amount of user benefits.

17. The online traffic dynamical adjustment and optimization method of claim 16, further comprising:
for the sub-platform, for which the traffic volume subset is monitored:
receiving the fifth amount of traffic units associated with the sub-platform; and
directing at least a part of the received fifth amount of traffic units to another sub-platform.

18. The online traffic dynamical adjustment and optimization method of claim 16, further comprising:
for the sub-platform, for which the traffic volume subset is monitored:
determining the amount of user benefits based at least in part on at least one of a number of users receiving the user benefits, a gross merchandise volume associated with users applying the user benefits, a number of users not receiving the user benefits, a gross merchandise volume associated with users not applying the user benefits, or a total value associated with the user benefits.

19. An online traffic dynamical adjustment and optimization system, comprising:
one or more servers configured to:
monitor an incoming traffic volume for visiting an online platform;
determine one or more unit traffic values of the monitored incoming traffic volume to the online platform; and
for each of a plurality of sub-platforms of the online platform, the plurality of sub-platform comprising one or more first sub-platforms and one or more second sub-platforms:
monitor a first subset of the incoming traffic volume for visiting the first sub-platform and a second subset of the incoming traffic volume for visiting the second sub-platform;
determine a first target traffic volume for the first sub-platform by a predetermined time based at least in part on the monitored first subset, and determine a second target traffic volume for the second sub-platform by the predetermined time based at least in part on the monitored second subset;
determine if the monitored first subset will meet the first target traffic volume by the predetermined time, and determine if the monitored second subset will meet the second target traffic volume by the predetermined time;
in response to determining that the monitored first traffic volume subset will not meet the first target traffic volume by the predetermined time and the monitored second traffic volume subset will not meet the second target traffic volume by the predetermined time, determine:
a first amount of traffic units for boosting the monitored first traffic volume subset based at least in part on the unit traffic value;
a second amount of traffic units for boosting the monitored second traffic volume subset based at least in part on the unit traffic value;
a third amount of traffic units to be directed to the first sub-platform if the monitored first traffic volume subset does not meet the first target traffic volume by the predetermined time; and
a fourth amount of traffic units to be directed to the second sub-platform if the monitored second traffic volume subset does not meet the second target traffic volume by the predetermined time; and
in response to determining a difference between the first and third amounts of traffic units outweighs a difference between the second and fourth amounts of traffic units, direct the first amount of traffic units to the first sub-platform and not redirect the second amount of traffic units to the second sub-platform.

20. The online traffic dynamical adjustment and optimization system of claim 19, wherein:
the one or more servers are configured to minimize the first, second, third, and fourth traffic units based at least in part on the unit traffic value.
